(19) United States
(12) Patent Application Publication
(10) Pub. No.: US 2026/0031748 A1
(43) Pub. Date: Jan. 29, 2026

(54) FASTENING TOOL

(71) Applicant: MAKITA CORPORATION, Anjo-shi (JP)

(72) Inventors: Kodai SAKAGAWA, Anjo-shi (JP); Toshihito YABUNAKA, Anjo-shi (JP)

(73) Assignee: MAKITA CORPORATION, Anjo-shi (JP)

(21) Appl. No.: 19/263,725

(22) Filed: Jul. 9, 2025

(30) Foreign Application Priority Data
Jul. 23, 2024 (JP) 2024-117701

(51) Int. Cl. H02P 3/22; B21J 15/10; B21J 15/26; B21J 15/28; B21J 15/32; H02P 23/00; H02P 23/20; H02P 23/24; H02P 27/08

(52) U.S. Cl. CPC H02P 3/22; B21J 15/105; B21J 15/26; B21J 15/285; B21J 15/32; H02P 23/0004; H02P 23/20; H02P 23/24; H02P 27/08

(57) ABSTRACT

A fastening tool includes a driving mechanism that is connected to perform rearward movement and forward movement, a position obtaining part that is configured to obtain a relative position of the driving mechanism, and a motor controlling part that is configured to change a moving direction and a moving speed of the driving mechanism. The motor controlling part starts the forward movement of the driving mechanism such that the moving speed reaches a first speed; reduces the moving speed to a second speed lower than the first speed by PWM control for changing a duty ratio outputted to the motor, when the obtained relative position reaches a deceleration position rearward of the initial position in the forward movement, and stops driving of the motor when the obtained relative position reaches a predetermined braking position forward of the deceleration position and rearward of the initial position.

### CROSS-REFERENCE TO RELATED APPLICATION

The present application claims priority to Japanese patent application No. 2024-117701 filed on Jul. 23, 2024. The contents of the foregoing applications are hereby fully incorporated herein by reference.

### TECHNICAL FIELD

The present disclosure relates to a fastening tool.

### BACKGROUND

A fastening tool is known that is configured to fasten workpieces via a fastener by pulling a pin of the fastener. In such a fastening tool, a driving mechanism connected to the pin gripping part is moved rearward from an initial position by power of a motor to pull the pin rearward along a driving axis. Subsequently, the driving mechanism is moved forward toward the initial position by power of the motor. For example, Japanese Unexamined Patent Application Publication No. 2019-000892 discloses a fastening tool in which the motor is braked to stop the driving mechanism when the driving mechanism moving toward the initial position enters a detection range of a sensor that is disposed in the initial position.

### SUMMARY

In such a prior art technique, the stop position where the driving mechanism stops at the initial position may be varied. This may cause a problem that the pin gripping part cannot properly grip the pin.

The present disclosure can be realized as the following aspects.

According to a first aspect of the present disclosure, a fastening tool is provided that is configured to fasten workpieces via a fastener having a pin and a cylindrical part. The fastening tool includes a motor having a motor shaft; a housing that houses the motor; a pin gripping part that is configured to grip the pin; a driving mechanism that is connected to the pin gripping part, and configured to perform rearward movement of moving rearward from an initial position along a driving axis that defines a front-rear direction of the fastening tool, by normal rotation of the motor shaft, and perform forward movement of moving forward to the initial position along the driving axis by reverse rotation of the motor shaft; a position obtaining part that is configured to obtain a relative position of the driving mechanism in the front-rear direction relative to the housing; and a motor controlling part that is configured to execute drive control of the motor to change a moving direction and a moving speed of the driving mechanism. The motor controlling part starts the forward movement of the driving mechanism such that the moving speed reaches a first speed; reduces the moving speed to a second speed lower than the first speed by PWM control for changing a duty ratio outputted to the motor, when the obtained relative position reaches a deceleration position rearward of the initial position in the forward movement; and stops driving of the motor when the obtained relative position reaches a predetermined braking position forward of the deceleration position and rearward of the initial position.

According to this aspect, the driving of the motor is stopped after the moving speed of the driving mechanism is reduced, so that variation in the stop position of the driving mechanism is reduced or prevented when the driving mechanism stops in the forward movement. The rotational speed of the motor shaft is accurately changed by PWM control, so that the moving speed of the driving mechanism is accurately changed. Thus, the occurrence of a problem that the pin gripping part cannot properly grip the pin is avoided or prevented.

According to a second aspect of the present disclosure, a fastening tool is provided that is configured to fasten workpieces via a fastener having a pin and a cylindrical part. The fastening tool includes a motor having a motor shaft; a housing that houses the motor; a pin gripping part that is configured to grip the pin; a driving mechanism that is connected to the pin gripping part, and configured to perform rearward movement of moving rearward from an initial position along a driving axis that defines a front-rear direction of the fastening tool, by normal rotation of the motor shaft, and perform forward movement of moving forward to the initial position along the driving axis by reverse rotation of the motor shaft; a position obtaining part that is configured to obtain a relative position of the driving mechanism in the front-rear direction relative to the housing; and a motor controlling part that is configured to execute drive control of the motor to change a moving direction and a moving speed of the driving mechanism. The motor controlling part starts the forward movement of the driving mechanism such that the moving speed reaches a first speed; reduces the moving speed to a second speed lower than the first speed by constant-speed rotation control for adjusting a driving voltage of the motor such that a number of revolutions per unit time of the motor shaft reaches a predetermined target number of revolutions, when the obtained relative position reaches a deceleration position rearward of the initial position in the forward movement; and stops driving of the motor when the obtained relative position reaches a predetermined braking position forward of the deceleration position and rearward of the initial position.

According to this aspect, the driving of the motor is stopped after the moving speed of the driving mechanism is reduced, so that variation in the stop position of the driving mechanism is reduced or prevented when the driving mechanism stops in the forward movement. The moving speed of the driving mechanism is accurately changed by constant-speed rotation control. Thus, the occurrence of a problem that the pin gripping part cannot properly grip the pin is avoided or prevented.

According to a third aspect of the present disclosure, a fastening tool is provided that is configured to fasten workpieces via a fastener having a pin and a cylindrical part. The fastening tool includes a motor having a motor shaft; a housing that houses the motor; a pin gripping part that is configured to grip the pin; a driving mechanism that is connected to the pin gripping part, and configured to perform rearward movement of moving rearward from an initial position along a driving axis that defines a front-rear direction of the fastening tool, by normal rotation of the motor shaft, and perform forward movement of moving forward to the initial position along the driving axis by reverse rotation of the motor shaft; a position obtaining part that is configured to obtain a relative position of the driving mechanism in the front-rear direction relative to the housing; and a motor controlling part that is configured to execute drive control of the motor to change a moving direction and a moving speed of the driving mechanism. The motor controlling part starts the forward movement of the driving mechanism such that the moving speed reaches a first speed; determines a negative acceleration such that the moving speed is reduced to a second speed lower than the first speed in a braking position located at a predetermined distance rearward from the initial position, and reduces the moving speed at the determined acceleration, when the moving speed reaches the first speed in the forward movement; and stops driving of the motor when the obtained relative position reaches the braking position.

According to this aspect, the driving of the motor is stopped after the moving speed of the driving mechanism is reduced, so that variation in the stop position of the driving mechanism is reduced or prevented when the driving mechanism stops in the forward movement. Thus, the occurrence of a problem that the pin gripping part cannot properly grip the pin is avoided or prevented.

The present disclosure can also be realized in various applications other than fastening tools, such as a control method for controlling a fastening tool, a computer program for implementing the control method, and a non-temporary storage medium storing the computer program.

### BRIEF DESCRIPTION OF THE DRAWINGS

FIG. 1 is an explanatory view showing an example of a fastener that can be used with a fastening tool according the present disclosure.

FIG. 2 is a longitudinal sectional view of the fastening tool with a screw shaft in an initial position.

FIG. 3 is an explanatory view showing a rear part of the fastening tool in an enlarged view.

FIG. 4 is a cross sectional view of a rear part of the fastening tool.

FIG. 5 is an explanatory view showing a front part of the fastening tool in an enlarged view.

FIG. 6 is a block diagram for illustrating the electrical structure of the fastening tool.

FIG. 7 is a block diagram for illustrating the internal functional configuration of a controller.

FIG. 8 is an explanatory view for illustrating the relationship between the position of the screw shaft and first and second sensors.

FIG. 9 is a flow chart of processing for drive control of a motor in rearward movement of the screw shaft.

FIG. 10 is a flow chart of processing for drive control of the motor in forward movement of the screw shaft.

FIG. 11 is a timing chart for expressing operation of each part in one cycle of fastening operation.

FIG. 12 is a flow chart of processing for drive control of the motor according to a second embodiment of the present disclosure.

FIG. 13 is a timing chart for fastening operation of the fastening tool according to the second embodiment.

### DETAILED DESCRIPTION OF THE EMBODIMENTS

Representative, non-limiting examples of the present invention are described in detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved tools and manufacturing and using methods of the tools.

Moreover, combinations of features and steps disclosed within the following detailed description may not be necessary to practice the invention in the broadest sense, and are instead taught merely to particularly describe representative examples of the invention. Furthermore, various features of the representative examples described above and below, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In at least one non-limiting embodiment according to the present disclosure, the position obtaining part may obtain a cumulative number of revolutions of the motor shaft and obtain the relative position by using the obtained cumulative number of revolutions of the motor shaft.

According to this embodiment, the position of the driving mechanism is obtained in a simple way.

In addition or in the alternative to the preceding embodiment, when the cumulative number of revolutions obtained in the forward movement reaches a predetermined cumulative number of revolutions, the position obtaining part may determine that the obtained relative position of the driving mechanism reaches the deceleration position.

According to this embodiment, a detecting part for detecting a detected object that is provided in the deceleration position can be omitted, so that increase of the number of parts of the fastening tool can be avoided or reduced. Further, the deceleration position can be more easily set and changed than a case in which such a detecting part is provided.

In addition or in the alternative to the preceding embodiments, the cumulative number of revolutions of the motor shaft in the forward movement from a position of starting the forward movement to the deceleration position may be smaller by a predetermined number of revolutions than the cumulative number of revolutions of the motor shaft in the rearward movement from a position of starting counting the cumulative number of revolutions of the motor shaft in the rearward movement to the position of starting the forward movement.

According to this embodiment, the deceleration position can be set rearward of the position of starting counting the cumulative number of revolutions of the motor shaft, by using the cumulative number of revolutions of the motor shaft.

In addition or in the alternative to the preceding embodiments, the position obtaining part may obtain a cumulative number of revolutions of the motor shaft. The position obtaining part may obtain a reaching position where the moving speed reaches the first speed, by using the obtained cumulative number of revolutions of the motor shaft. The position obtaining part may calculate a distance from the obtained reaching position to the braking position. The motor controlling part may calculate the negative acceleration by using the calculated distance from the reaching position to the braking position and reduce the moving speed at the calculated negative acceleration.

According to this embodiment, even if the reaching position varies, the moving speed in the braking position is reduced to the second speed. Thus, variation in the stop position of the driving mechanism due to variation of the reaching position is reduced or prevented.

In addition or in the alternative to the preceding embodiments, the motor controlling part may reduce the moving speed at a constant negative acceleration corresponding to the distance from the obtained reaching position to the braking position.

According to this embodiment, the cost for calculating the acceleration is reduced.

In addition or in the alternative to the preceding embodiments, the fastening tool may further include a detected object that is provided in the driving mechanism and moves integrally with the driving mechanism, and a braking position detecting part that is configured to detect the detected object when the driving mechanism is located in the braking position. The position obtaining part may start obtaining the cumulative number of revolutions of the motor shaft at the timing when a detection result of the braking position detecting part is changed from a detection state in which the detected object is detected to a non-detection state in which the detected object is not detected, in the rearward movement.

According to this embodiment, the accuracy in estimating the position of the driving mechanism is improved compared with a case in which the counting of the cumulative number of revolutions of the motor shaft is started from the time when the driving mechanism starts the rearward movement.

In addition or in the alternative to the preceding embodiments, the motor controlling part may change the moving speed by PWM control for changing a duty ratio outputted to the motor.

According to this embodiment, the rotational speed of the motor shaft is accurately changed by PWM control, so that the moving speed of the driving mechanism is accurately changed.

In addition or in the alternative to the preceding embodiments, the motor controlling part may execute constant-speed rotation control for adjusting a driving voltage of the motor such that a number of revolutions per unit time of the motor shaft reaches a predetermined target number of revolutions. The motor controlling part may change the moving speed by changing the target number of revolutions.

According to this embodiment, the moving speed of the driving mechanism is accurately changed by constant-speed rotation control.

In addition or in the alternative to the preceding embodiments, the motor controlling part may stop the motor by short-circuit braking for short-circuiting terminals of the motor.

According to this embodiment, the time required for stopping the motor is shortened. Further, a braking distance of the driving mechanism is shortened, so that variation in the stop position of the driving mechanism is reduced or prevented.

In addition or in the alternative to the preceding embodiments, the driving mechanism may include a nut that is rotationally driven around the driving axis by power of the motor, and a shaft that is connected to the pin gripping part and configured to perform the rearward movement by normal rotation of the motor shaft and perform the forward movement by reverse rotation of the motor shaft.

According to this embodiment, the moving direction and the moving speed of the driving mechanism can be accurately changed by a so-called feed screw mechanism.

In addition or in the alternative to the preceding embodiments, the fastening tool may further include a detected object that is provided in the driving mechanism and moves integrally with the driving mechanism, and a rear braking position detecting part that is configured to detect the detected object when the driving mechanism is located in a rear braking position rearward of the braking position. The motor controlling part may stop driving of the motor when the detected object is detected by the rear braking position detecting part.

According to this embodiment, the driving mechanism in the rear detection position can be detected in a simpler way than a case in which the position of the driving mechanism is estimated by using the number of revolutions of the motor.

In addition or in the alternative to the preceding embodiments, the fastening tool may further include a trigger that is configured to be depressed or released by a user. The motor controlling part may drive the motor to rotate the motor shaft in a normal direction when the trigger is depressed, while driving the motor to rotate the motor shaft in a reverse direction when the trigger is released.

According to this embodiment, a user can switch between forward movement and rearward movement of the driving mechanism simply by operating the trigger.

### A. First Embodiment

### A1. The Structure of the Fastener:

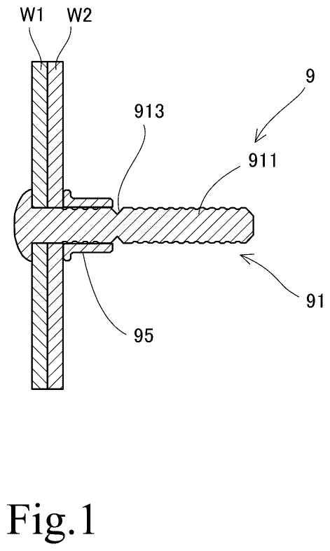

FIG. 1 shows an example of a fastener that can be used with a fastening tool 1 according to the present disclosure. The fastener 9 has a pin 91 and a collar 95. The fastener 9 is of a tearing-off type (specifically, a multi-piece swage type fastener) in which a part of a shaft part 911 of the pin 91, which is a so-called pintail or mandrel, is torn off. The collar 95 is generally cylindrical and is configured such that the shaft part 911 can be inserted therethrough. The collar 95 is an example of the “cylindrical part”.

### A2. The External Structure of the Fastening Tool 1:

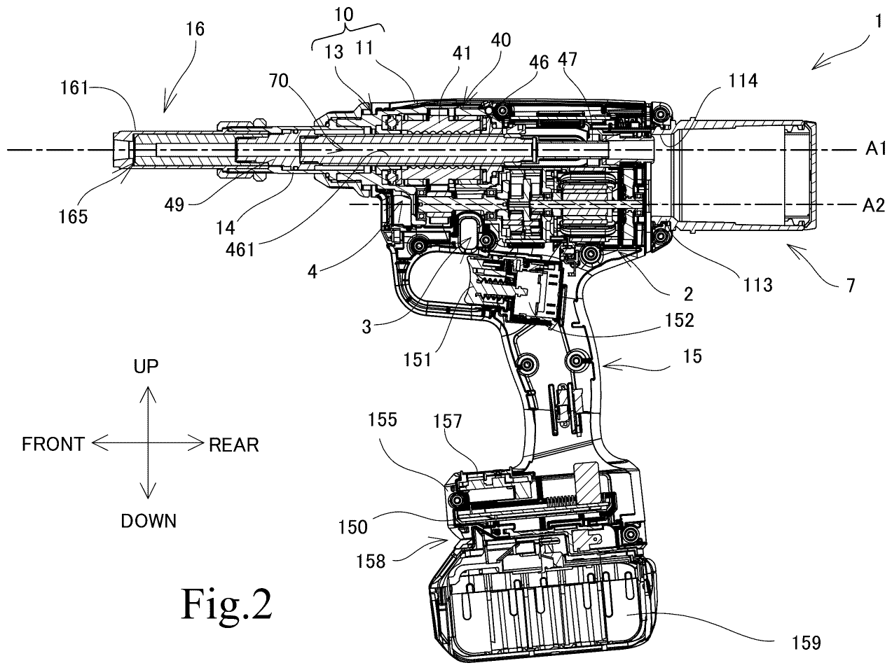

The fastening tool 1 that is configured to fasten workpieces by using the fastener 9 is now described with reference to FIG. 2 as an example of the fastening tool of the present disclosure. As shown in FIG. 2, an outer shell of the fastening tool 1 is formed by an outer housing 11, a handle 15 and a nose 16. The outer housing 11 has a generally rectangular box-like shape and extends along a prescribed driving axis A1. As shown in FIG. 2, the outer housing 11 houses a motor 2, a driving mechanism 4 and a transmitting mechanism 3. An inner housing 13 is fixed within the outer housing 11. The outer housing 11 and the inner housing 13 form an integral housing 10.

The nose 16 is arranged to extend along the driving axis A1. The nose 16 includes a cylindrical anvil 161 and a pin gripping part 165 that is arranged within the anvil 161. The anvil 161 is connected to one end part of the outer housing 11 in the axial direction. A collecting container 7 is configured to collect the shaft part 911 that is separated from the fastener 9 in a fastening process, and removably attached to the other end part of the outer housing 11.

The handle 15 is configured to be held by a user. The handle 15 protrudes in a direction crossing the driving axis A1 (in a direction substantially orthogonal to the driving axis A1 in this embodiment) from substantially the center of the outer housing 11 in the axial direction.

In this specification, as for the direction of the fastening tool 1, the extending direction of the driving axis A1 (or the axial direction of the outer housing 11) is defined as a front-rear direction of the fastening tool 1. In the front-rear direction, the side on which the nose 16 is arranged is defined as a front side and the side on which the collecting container 7 is arranged is defined as a rear side. Further, a direction orthogonal to the driving axis A1 and corresponding to the extending direction of the handle 15 is defined as an up-down direction. In the up-down direction, the side on which the outer housing 11 is arranged is defined as an upper side, and the side of a protruding end (free end) of the handle 15 is defined as a lower side. A direction orthogonal to the front-rear direction and the up-down direction is defined as a left-right direction.

An upper end part of the handle 15 serves as a base end part that is connected to the outer housing 11. A trigger 151 is provided in an upper end part of the handle 15 and configured to be depressed and released by a user. A battery mounting part 158 is provided in a lower end part of the handle 15 and configured such that a battery 159 can be removably mounted thereto. The battery 159 is a rechargeable power source, which is, for example, a known battery pack or secondary battery, such as a lithium-ion battery including a plurality of cells. The battery 159 supplies power to various parts of the fastening tool 1 and the motor 2.

The fastening tool 1 is configured to fasten workpieces W1, W2 via the fastener 9.

When part of the shaft part 911 of the fastener 9 is inserted into a front end part of the nose 16 of the fastening tool 1, the fastener 9 is held by the pin gripping part 165 (described below) while being engaged with a front end part of the anvil 161.

A3. The Structures of Elements Disposed within the Fastening Tool 1:

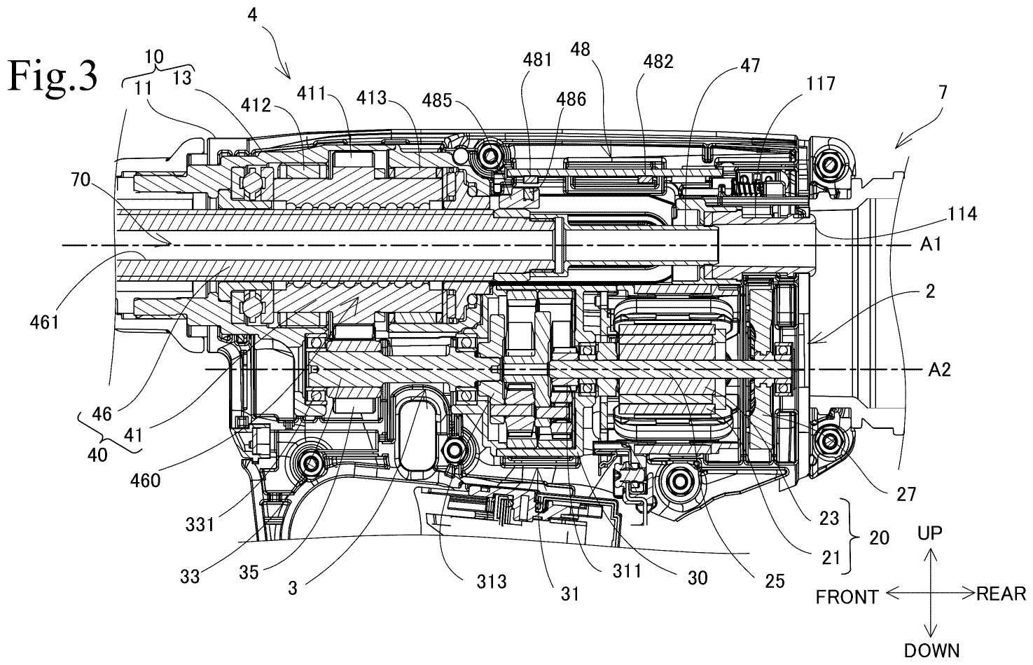

The structures of elements disposed within the fastening tool 1 are now described with reference to FIGS. 3 to 5. The housing 10 houses the motor 2, the driving mechanism 4 configured to be driven by power of the motor 2, and the transmitting mechanism 3 configured to transmit power of the motor 2 to the driving mechanism 4.

The motor 2 is, for example, a brushless direct current (DC) motor. As shown in FIG. 3, the motor 2 is housed in a lower rear end part of the outer housing 11. In this embodiment, the whole of the motor 2 is arranged below the driving axis A1. The motor 2 includes a motor body 20 and a motor shaft 25. The motor body 20 includes a stator 21 and a rotor 23. The motor shaft 25 is configured to extend from the rotor 23 and rotate integrally with the rotor 23. The motor 2 is arranged such that a rotational axis A2 of the motor shaft 25 extends in parallel to the driving axis A1 below the driving axis A1. The rotational axis A2 extends in the front-rear direction. A front end part of the motor shaft 25 protrudes into a reduction gear housing 30. A fan 27 for cooling the motor 2 is fixed on a rear end part of the motor shaft 25.

As shown in FIG. 3, the transmitting mechanism 3 includes a planetary reduction gear (planetary gear reducer) 31, an intermediate shaft 33 and a nut driving gear 35. The planetary reduction gear 31 is arranged in front of the motor 2. The rotational power is transmitted from the motor shaft 25 to the planetary reduction gear 31. In a power transmission path from the motor 2 to a ball screw mechanism 40 of the driving mechanism 4, the planetary reduction gear 31 increases torque of the motor 2 and transmits the torque to the intermediate shaft 33.

The planetary reduction gear 31 includes two sets of planetary gear mechanisms and the reduction gear housing 30 formed of resin. The reduction gear housing 30 is arranged in front of the motor 2 and fixed to the outer housing 11. The reduction gear housing 30 houses the two sets of planetary gear mechanisms. A sun gear 311 is fixed onto the front end part of the motor shaft 25. The sun gear 311 is provided in the planetary gear mechanism on the upstream side of the planetary reduction gear 31. A carrier 313 is provided in the planetary gear mechanism on the downstream side of the planetary reduction gear 31. The carrier 313 is a final output shaft of the planetary reduction gear 31.

The intermediate shaft 33 is arranged rotatably and coaxially with the motor shaft 25. A rear end part of the intermediate shaft 33 is connected to the carrier 331. Thus, the intermediate shaft 33 rotates integrally with the carrier 313. The nut driving gear 35 is fixed on an outer periphery of a front end part of the intermediate shaft 33. The nut driving gear 35 is engaged with a driven gear 411 formed on an outer periphery of a nut 41 (described below) and transmits the rotational power of the intermediate shaft 33 to the nut 41. The nut driving gear 35 and the driven gear 411 form a speed-reducing gear mechanism.

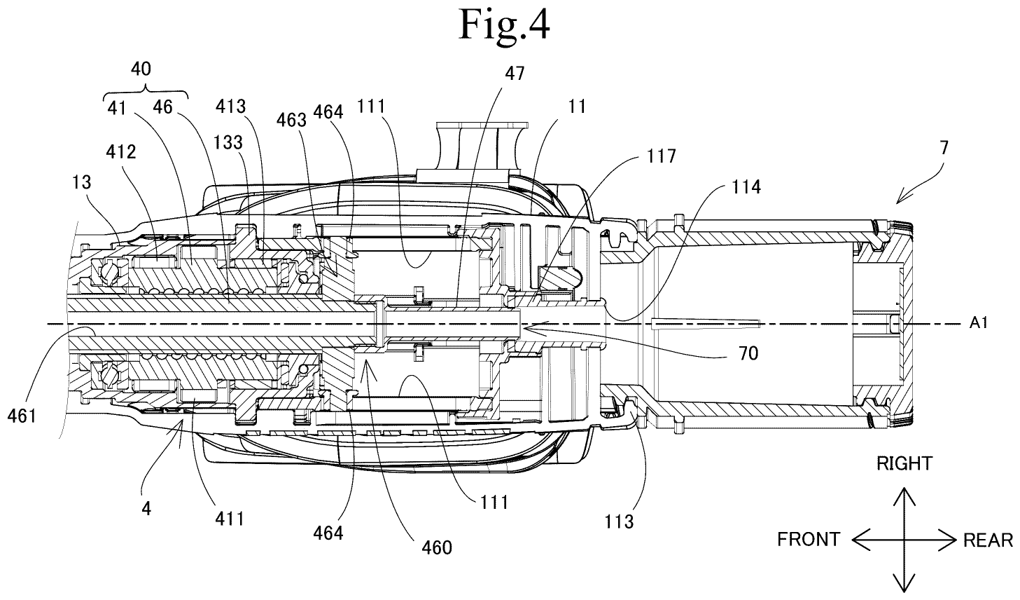

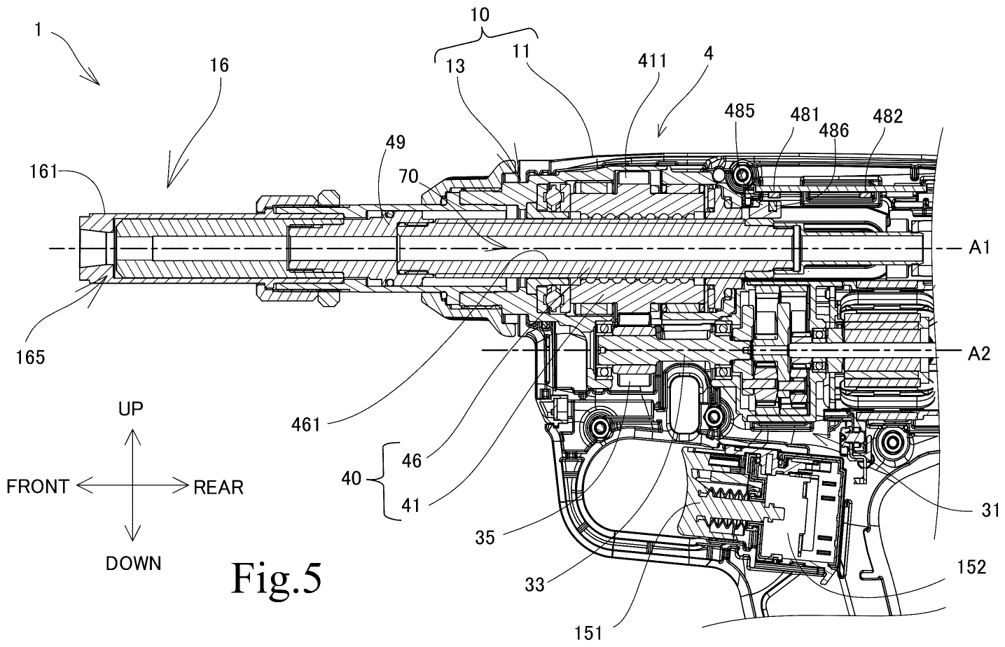

As shown in FIG. 3, the driving mechanism 4 is connected to the pin gripping part 165 described below (see FIG. 5). The driving mechanism 4 moves in the front-rear direction along the driving axis A1 by power of the motor 2 and moves the pin gripping part 165 in the front-rear direction. In this embodiment, the driving mechanism 4 is formed by the ball screw mechanism 40 housed in an upper part of the outer housing 11. As shown in FIGS. 3 and 4, the ball screw mechanism 40 includes a nut 41 and a screw shaft 46. The ball screw mechanism 40 is configured to convert rotation of the nut 41 into linear motion of the screw shaft 46 and to linearly move the pin gripping part 165.

The nut 41 has a hollow cylindrical shape. The nut 41 is supported by the inner housing 13 so as to be immovable in the front-rear direction and rotatable around the driving axis A1. The driven gear 411 is formed on an outer periphery of the nut 41. The nut 41 is supported by the inner housing 13 via a pair of radial bearings 412, 413 provided on the front and rear sides of the driven gear 411 so as to be rotatable around the driving axis A1. The driven gear 411 is engaged with the nut driving gear 35. The nut 41 is rotated around the driving axis A1 when the driven gear 411 receives the rotational power of the motor 2 via the nut driving gear 35.

The screw shaft 46 is a generally elongate cylindrical member extending along the driving axis A1. The screw shaft 46 is an example of the “shaft”. The screw shaft 46 is inserted through the nut 41. The screw shaft 46 is engaged with the nut 41 so as to be movable in the front-rear direction along the driving axis A1. A spiral track is formed between the screw shaft 46 and the nut 41. The spiral track is defined between a spiral groove formed in an inner peripheral surface of the nut 41 and a spiral groove formed in an outer peripheral surface of the screw shaft 46. A plurality of balls (not shown) are rollably disposed in the spiral track. The screw shaft 46 is engaged with the nut 41 via these balls. The screw shaft 46 is linearly moved in the front-rear direction along the driving axis A1 by rotational driving of the nut 41.

As shown in FIG. 4, a central part of a roller holding part 463 is fixed onto of a rear end part of the screw shaft 46. The roller holding part 463 has a pair of arms. Each of the arms is a member extending orthogonally to the screw shaft 46 and protruding in the left-right direction from the central part of the roller holding part 463. A roller 464 is rotatably held on an end part of each of the arms. A pair of roller guides 111 are provided corresponding to the pair of left and right rollers 464 on left and right inner wall parts of the outer housing 11. The roller guides 111 restrict movement of the rollers 464 in the up-down direction. The roller 464 disposed in each of the roller guides 111 rolls in the front-rear direction along the roller guide 111. Rotation of the screw shaft 46 around the driving axis A1 along with rotation of the nut 41 is restricted by abutment of the roller 464 on the roller guide 111,

As shown in FIG. 3, a magnet holding part 485 is fixed on an upper rear end part of the screw shaft 46. A magnet 486 is mounted on an upper end of the magnet holding part 485. The magnet 486 is an example of the “detected object”. The magnet 486 is integrated to the screw shaft 46 and moves integrally in the front-rear direction along with movement of the screw shaft 46 in the front-rear direction.

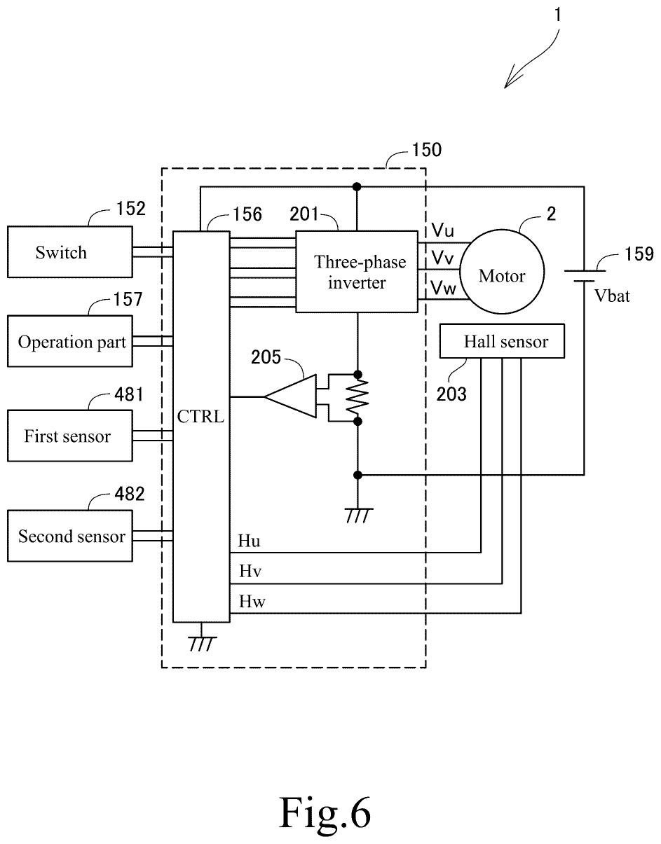

A position detecting mechanism 48 is provided in the outer housing 11 and configured to detect the magnet 486. The position detecting mechanism 48 includes a first sensor 481 and a second sensor 482. The second sensor 482 is arranged behind the first sensor 481. The first and second sensors 481, 482 are, for example, magnetic field detection type sensors, and in this embodiment, they are Hall sensors having Hall elements. The first sensor 481 is an example of the “braking position detecting part”, and the second sensor 482 is an example of the “rear braking position detecting part”. The first and second sensors 481, 482 are electrically connected to a controller 156 (see FIG. 6) via wires (not shown). The first and second sensors 481, 482 respectively output prescribed signals to the controller 156 upon respectively detecting the presence of the magnet 486 within respective detection ranges. In this embodiment, detection results of the first and second sensors 481, 482 are used for drive control of the motor 2 by the controller 156.

As shown in FIGS. 3 and 4, an extension shaft 47 is coaxially connected and fixed to the rear end part of the screw shaft 46 and integrated with the screw shaft 46. The screw shaft 46 and the extension shaft 47 that are integrated with each other are hereinafter also collectively referred to as a “driving shaft 460”. The driving shaft 460 has a through hole 461 extending therethrough along the driving axis A1. The diameter of the through hole 461 is set slightly larger than the maximum diameter of the shaft part 911 of the fastener 9 that can be used with the fastening tool 1.

An opening 114 is formed on the driving axis A1 in the rear end part of the outer housing 11 and communicates the inside of the outer housing 11 with the outside. A cylindrical guide sleeve 117 is fixed in front of the opening 114. The inner diameter of the guide sleeve 117 is substantially equal to the outer diameter of the extension shaft 47. When the screw shaft 46 is placed in an initial position shown in FIGS. 3 and 4, a rear end of the extension shaft 47 is located within the guide sleeve 117. When the screw shaft 46 is moved rearward from the initial position along with rotation of the nut 41, the extension shaft 47 is moved rearward within the guide sleeve 117.

As shown in FIGS. 3 and 4, a container connecting part 113 is formed in the rear end part of the outer housing 11. The container connecting part 113 is configured such that the collecting container 7 for collecting the broken (torn-off) shaft part 911 can be removably attached thereto. A user can attach the collecting container 7 to the outer housing 11 such that the inside space of the collecting container 7 communicates with the opening 114 via the container connecting part 113.

As shown in FIG. 5, the nose 16 includes the cylindrical anvil 161 that is configured to abut on the collar 95 of the fastener 9, and the pin gripping part 165 that is configured to grip the shaft part 911 of the fastener 9. The anvil 161 is removably connected to the front end part of the housing 10 via a prescribed connecting member. The pin gripping part 165 is held coaxially within the anvil 161 so as to be slidable along the driving axis A1 relative to the anvil 161.

The pin gripping part 165 is integrally connected to the screw shaft 46 via a connecting member 49. Thus, a passage 70 is defined extending from a front end of the pin gripping part 165 to the opening 114 of the outer housing 11 along the driving axis A1. The shaft part 911 separated from the fastener 9 passes through the passage 70 and is collected in the collecting container 7.

As shown in FIG. 2, the trigger 151 is provided in an upper end front part of the handle 15. A switch 152 is housed within the handle 15 behind the trigger 151 and turned on and off according to depressing operation of the trigger 151.

A lower end part of the handle 15 has a rectangular box-like shape and forms a controller housing part 155. A circuit board 150 is housed in the controller housing part 155. The controller 156 for controlling operation of the fastening tool 1, a three-phase inverter 201 and a current detecting amplifier 205 are mounted on the circuit board 150 as described below. An operation part 157 is provided in an upper part of the controller housing part 155 and configured to input various information according to user's external operation.

When the trigger 151 is depressed by a user, the motor 2 is driven and the driving mechanism 4 is driven via the motor 2. When the pin gripping part 165 is moved rearward along the driving axis A1 relative to the anvil 161 while gripping the shaft part 911 of the fastener 9, the pin 91 is pulled rearward relative to the collar 95. In the case of using the tearing-off type fastener 9 shown in FIG. 1, the collar 95 is then deformed and swaged onto the shaft part 911 of the pin 91, and the workpieces W1, W2 are clamped between a head 915 of the pin 91 and the collar 95. Subsequently, the shaft part 911 is torn off and separated at a small-diameter part 913, and the operation of fastening the workpieces W1, W2 is completed.

The fastening tool 1 of this embodiment is configured to perform a fastening operation of fastening workpieces by using the fastener 9, with the operation of the driving mechanism 4 to move the pin gripping part 165 rearward from the initial position to a stop position and then return it to the initial position, as one cycle.

### A4: The Electrical Structure of the Fastening Tool 1:

As shown in FIG. 6, the fastening tool 1 includes the three-phase inverter 201, a Hall sensor 203 and the controller 156. The three-phase inverter 201 has a three-phase bridge circuit using six semiconductor switching elements. The three-phase inverter 201 executes switching operation of each of the switching elements of the three-phase bridge circuit according to a duty ratio indicated by a control signal from the controller 156. As a result, a drive pulse corresponding to the duty ratio is supplied to the motor 2. The Hall sensor 203 has three Hall elements arranged corresponding to respective phases of the motor 2. The Hall sensor 203 outputs a signal indicating a rotation angle of the rotor 23 to the controller 156.

The current detecting amplifier 205 is electrically connected to the controller 156. The current detecting amplifier 205 converts the driving current of the motor 2 to a voltage by a shunt resistor and outputs a signal amplified by the amplifier to the controller 156.

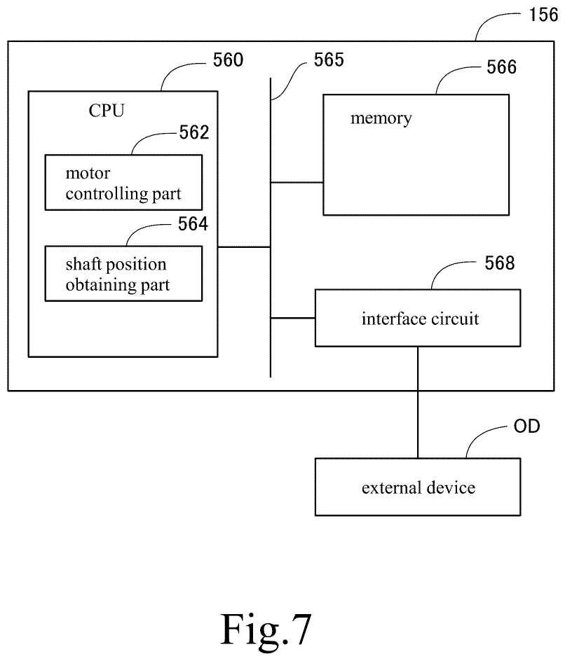

As shown in FIG. 7, the controller 156 is formed by a computer having a CPU 560 as a processor, a memory 566 including a ROM and a RAM, an interface circuit 568 and a timer (not shown). These elements are connected to bidirectionally communicate with each other via an internal bus 565. An external device OD, including the switch 152, the operation part 157, the first and second sensors 481, 482 and the three-phase inverter 201, which are shown in FIG. 6, is connected to the interface circuit 568.

The memory 566 stores programs for executing functions to be performed by the fastening tool 1 of this embodiment. As shown in FIG. 7, the CPU 560 reads out and executes the programs stored in the memory 566 so that the controller 156 functions as a motor controlling part 562 and a shaft position obtaining part 564. The shaft position obtaining part 564 is an example of the “position obtaining part”.

The motor controlling part 562 controls driving of the motor 2 based on signals from the external device OD. In this embodiment, the motor controlling part 562 changes the moving direction and the moving speed of the screw shaft 46 by controlling driving of the motor 2. The motor controlling part 562 controls, for example, energization to the motor 2 via the three-phase inverter 201 based on a signal from the Hall sensor 203. As a result, the rotational speed of the motor 2 is controlled and the moving speed of the screw shaft 46 is changed. In this embodiment, the rotational speed is controlled by PWM control.

The motor controlling part 562 is capable of switching the rotating direction of the rotor 23 of the motor 2 or the rotating direction of the motor shaft 25 between normal direction and reverse direction. The “normal direction” means a rotating direction to move the screw shaft 46 of the driving mechanism 4 rearward relative to the housing 10, and the “reverse direction” means a rotating direction to move the screw shaft 46 of the driving mechanism 4 forward relative to the housing 10. When the trigger 151 is depressed by the user and the switch 152 is turned on, the motor controlling part 562 drives the motor 2 to rotate the nut 41 in the normal direction and moves the screw shaft 46 rearward. When the trigger 151 is released by the user and the switch 152 is turned off, the motor controlling part 562 drives the motor 2 to rotate the nut 41 in the reverse direction and moves the screw shaft 46 forward. With such a structure, the user can switch between forward movement and rearward movement of the screw shaft 46 simply by operating the trigger 151.

The shaft position obtaining part 564 obtains the relative position of the driving mechanism 4 in the front-rear direction relative to the housing 10, based on signals from the external device OD. In this embodiment, the shaft position obtaining part 564 obtains the relative position of the screw shaft 46 of the driving mechanism 4 (hereinafter simply referred to as a “position of the screw shaft 46”). In this embodiment, the shaft position obtaining part 564 obtains the position of the screw shaft 46, based on the detection results of the first and second sensors 481, 482, the number of revolutions (rotational angle) of the motor 2 that is obtained from the Hall sensor 203, the number of drive pulses supplied to the motor 2 and the driving time of the motor 2, or by operation using these information. The “number of revolutions of the motor 2” includes the number of revolutions of the motor shaft 25 and the number of revolutions of the rotor 23. “Obtaining the position of the screw shaft 46” includes estimating the position of the screw shaft 46 by arithmetic operation.

### A5. The Relationship Between the Position of the Screw Shaft 46 in the Front-Rear Direction and the Drive Control of the Motor 2:

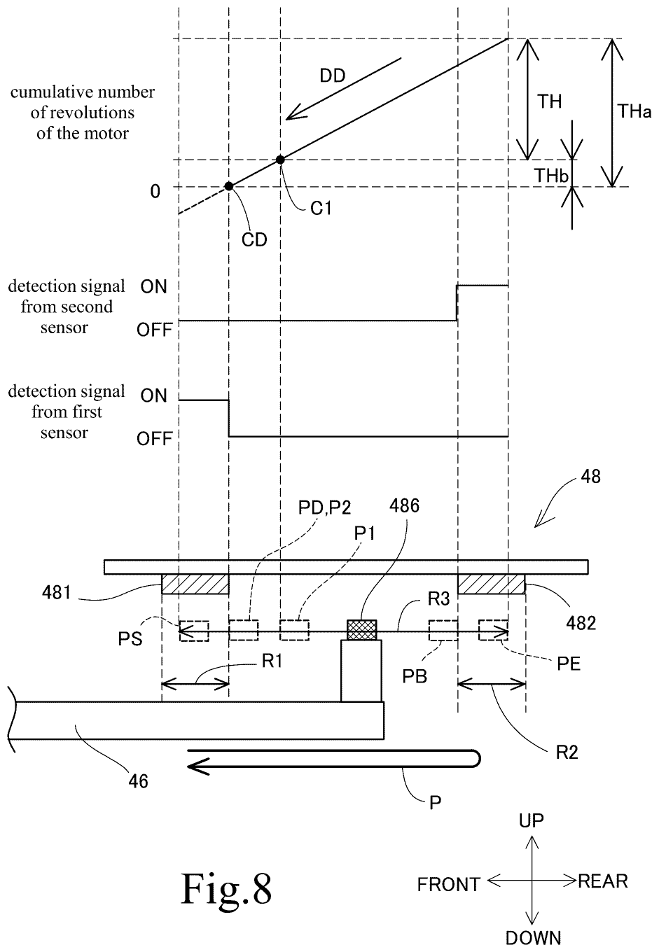

The relationship between the drive control of the motor 2 by the fastening tool 1 of the present disclosure and the position of the screw shaft 46 in the front-rear direction is now described with reference to FIG. 8. The shaft position obtaining part 564 obtains the position of the screw shaft 46 in the front-rear direction, based on the detection results of the first and second sensors 481, 482 and the cumulative number of revolutions of the motor 2 that is obtained from the Hall sensor 203. The motor controlling part 562 executes drive control of the motor 2 corresponding to the obtained position of the screw shaft 46 in the front-rear direction.

As shown at the bottom of FIG. 8, an arrow P shows the moving direction of the screw shaft 46 and the magnet 486 in one cycle. In this embodiment, in one cycle of fastening operation of the fastener 9, the screw shaft 46 moves rearward from an initial position PS to a stop position PE and thereafter moves back from the stop position PE to the initial position PS. As described above, the magnet 486 is integral with the screw shaft 46, so that the position of the screw shaft 46 and the pin gripping part 165 corresponds to the position of the magnet 486. In the following description, for convenience of explanation, the position of the screw shaft 46 may be indicated by using the same symbol as the position of the magnet 486.

A detection range R1 of the first sensor 481, a detection range R2 of the second sensor 482 and a moving range R3 of the magnet 486 are schematically shown in FIG. 8. When the screw shaft 46 is located in the initial position PS, the magnet 486 is located within the detection range R1 of the first sensor 481. If, for example, the screw shaft 46 fails to accurately return to the initial position PS when one cycle of fastening operation is completed, the pin gripping part 165 may not be able to properly grip the pin 91. Therefore, it is preferable to stop the screw shaft 46 in the initial position PS as accurately as possible.

As shown in a middle stage of FIG. 8, when the screw shaft 46 is located in the initial position PS, the first sensor 481 detects the magnet 486 and outputs a detection signal to the controller 156. When the motor 2 is driven and the screw shaft 46 moves rearward, the magnet 486 reaches a non-detection position PD outside of the detection range R1. The rearward movement of the screw shaft 46 is also referred to as “rearward movement”. In the non-detection position PD, the output of a detection signal from the first sensor 481 is changed from ON to OFF.

When the screw shaft 46 further moves rearward from the non-detection position PD, the magnet 486 reaches the rear detection position PB in which the magnet 486 enters the detection range R2 of the second sensor 482. In the rear detection position PB, an output of a detection signal from the second sensor 482 is changed from ON to OFF. The rear detection position PB is an example of the “rear braking position”. The magnet 486 is detected when the output of a detection signal from the first sensor 481 or the second sensor 482 is ON, and the magnet 486 is not detected when the output of a detection signal from the first sensor 481 or the second sensor 482 is OFF. The state in which the output of a detection signal from the first sensor 481 or the second sensor 482 is ON is also referred to as a “detection state”, and the state in which it is OFF is also referred to as a “non-detection state”.

When the magnet 486 reaches the rear detection position PB and a detection signal from the second sensor 482 is detected, the motor controlling part 562 executes control for braking the motor 2. The screw shaft 46 moves rearward until the motor 2 completely stops after start of the braking. When the motor 2 completely stops, the magnet 486 stops at the stop position PE within the detection range R2. When the screw shaft 46 is located in the stop position PE, the second sensor 482 outputs a detection signal. Driving of the motor 2 is stopped based on the detection result from the second sensor 482, so that the screw shaft 46 in the rear detection position PB can be detected in a simpler way than a case in which the position of the screw shaft 46 is estimated from the number of revolutions of the motor 2.

In this embodiment, the shaft position obtaining part 564 estimates the position of the screw shaft 46, based on the number of revolutions of the motor 2 that is obtained from the Hall sensor 203. The correspondence between the number of revolutions of the motor 2 that is obtained by the shaft position obtaining part 564 and the position of the magnet 486 is shown in an upper stage of FIG. 8. In an example shown in FIG. 8, a cumulative number of revolutions in the normal rotation of the motor 2 is shown. Specifically, the cumulative number of revolutions of the motor 2 is increased as the screw shaft 46 moves rearward, while being reduced as the screw shaft 46 moves forward.

In this embodiment, the shaft position obtaining part 564 is configured to start counting the cumulative number of revolutions of the motor 2 from a point of time, which is shown by a position CD in the upper stage of FIG. 8, when the screw shaft 46 reaches the non-detection position PD and the output of the detection signal from the first sensor 481 is changed from ON to OFF. This configuration reduces the influence of variation in the initial position PS upon the counting of the cumulative number of revolutions of the motor 2. Thus, the accuracy in estimating the position of the screw shaft 46 is improved compared with a case in which the counting of the cumulative number of revolutions of the motor 2 is started from the initial position PS.

When the switch 152 is turned off by releasing operation of the trigger 151, the screw shaft 46 moves forward toward the initial position PS as shown by an arrow DD in the upper stage of FIG. 8. The forward movement of the screw shaft 46 is referred to as “forward movement”. The forward movement of the screw shaft 46 can be started at any position between the initial position PS and the stop position PE.

A target speed V1 of the screw shaft 46 in the forward movement can be freely set. In this embodiment, the target speed V1 is a maximum speed of the screw shaft 46 that can be realized by the motor 2. The target speed V1 is an example of the “first speed”. When the screw shaft 46 moves forward from the stop position PE, the magnet 486 is moved out of the detection range R2 and the output of the detection signal from the second sensor 482 is changed from ON to OFF. When the screw shaft 46 further moves forward, the magnet 486 reaches a deceleration position P1.

The deceleration position P1 is located rearward of the initial position PS. The deceleration position P1 is preset, for example, based on results of experiments carried out in advance, such that the positional accuracy of the screw shaft 46 stopped at the initial position PS is improved. The deceleration position P1 is set to be located 1.0 to 5.0 mm from a braking position P2 (described below), for example, when the screw shaft 46 starts forward movement from the stop position PE.

In this embodiment, the deceleration position P1 is set based on the cumulative number of revolutions of the motor 2. Thus, the shaft position obtaining part 564 is configured to determine whether the magnet 486 reaches the deceleration position P1, based on the cumulative number of revolutions of the motor 2. This configuration can omit (eliminate the need for) a detecting part for detecting the magnet 486 in the deceleration position P1, and thus can avoid or reduce increase of the number of parts of the fastening tool 1. Further, the deceleration position P1 can be more easily set and changed than in a case where such a detecting part is provided. In this embodiment, the deceleration position P1 is set at a position, which is shown by a position point C1 in the upper stage of FIG. 8, where the cumulative number of revolutions of the motor 2 reaches a predetermined cumulative number of revolutions TH after start of the forward movement of the screw shaft 46. The cumulative number of revolutions TH of the motor 2 in the forward movement of the screw shaft 46 from the stop position PE where the screw shaft 46 starts forward movement, to the deceleration position P1 is designed to be smaller by a predetermined number of revolutions THb than a cumulative number of revolutions THa of the motor 2 in the rearward movement of the screw shaft 46 from the non-detection position PD where the counting of the cumulative number of revolutions of the motor 2 is started, to the stop position PE. The deceleration position P1 is set to be located rearward of the non-detection position PD by a distance corresponding to the cumulative number of revolutions THb when the screw shaft 46 starts forward movement from the stop position PE.

The shaft position obtaining part 564 starts counting the cumulative number of revolutions of the motor 2 at the timing when the screw shaft 46 start forward movement. When the cumulative number of revolutions of the motor 2 reaches the predetermined cumulative number of revolutions TH, the shaft position obtaining part 564 determines that the screw shaft 46 reaches the deceleration position P1.

When the screw shaft 46 reaches the deceleration position P1, the motor controlling part 562 controls the motor 2 to change the speed of the screw shaft 46 to a target speed V2 lower than the target speed V1. In this embodiment, the motor controlling part 562 reduces the rotational speed of the motor 2 such that the moving speed of the screw shaft 46 is reduced to about 50 percent of the target speed V1.

The target speed V2 is preferably set to be 50 to 70 percent of the target speed V1 in order to improve the accuracy of the stop position of the screw shaft 46. The target speed V2 is an example of the “second speed”. In this embodiment, the motor controlling part 562 reduces the number of revolutions per unit time of the motor 2 by PWM control for changing the duty ratio outputted to the motor 2. The rotational speed of the motor 2 is accurately changed by PWM control, so that the moving speed of the screw shaft 46 is accurately changed.

When the screw shaft 46 further moves forward from the deceleration position P1, the screw shaft 46 reaches the braking position P2 where the output of the detection signal from the first sensor 481 is changed from OFF to ON. The braking position P2 substantially corresponds to the non-detection position PD. When the output of the detection signal from the first sensor 481 is changed from OFF to ON, the shaft position obtaining part 564 determines that the screw shaft 46 reaches the braking position P2.

When the screw shaft 46 reaches the braking position P2, the motor controlling part 562 controls the motor 2 to brake the screw shaft 46. Even after the motor 2 is braked, the screw shaft 46 moves forward until the motor 2 is completely stopped, and stops at the initial position PS. In this embodiment, the motor controlling part 562 is configured to stop the motor 2 by short-circuit braking for short-circuiting terminals of the motor 2. With this configuration, the time required for stopping the motor 2 is shortened. Further, a braking distance of the screw shaft 46 is shortened, so that variation in the stop position of the screw shaft 46 is reduced or prevented. The short-circuit braking includes three-phase short-circuit braking and two-phase short-circuit braking.

### A6. Drive Control of the Motor 2:

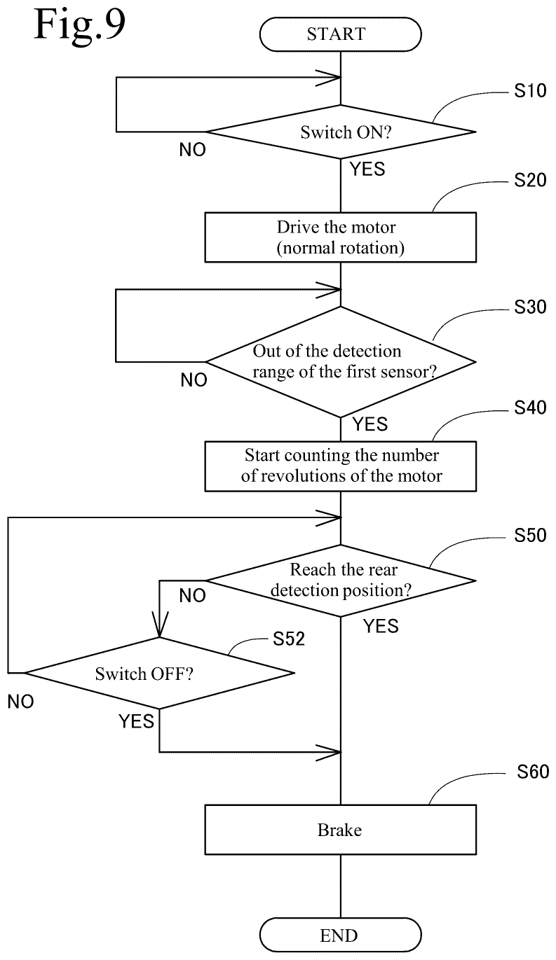

A flow of drive control of the motor 2 in one cycle of fastening operation of the fastener 9 is described with reference to FIGS. 9 to 11. FIG. 9 shows a (first) flow that is started while the trigger 151 is released and the screw shaft 46 is placed in the initial position PS. In the following description, each “step” in the processing (flow) is abbreviated as “S”.

In S10, the motor controlling part 562 waits for the switch 152 to be turned on by depressing operation of the trigger 151. If the switch 152 is turned on by the depressing operation of the trigger 151 (S10: YES), the motor controlling part 562 shifts the processing to S20, and rotates the motor 2 in the normal direction and moves the screw shaft 46 rearward. The motor controlling part 562 controls, for example, the speed of the rearward movement of the screw shaft 46 to the target speed V1.

In S30, the shaft position obtaining part 564 monitors the output of the detection signal from the first sensor 481. If the output of the detection signal from the first sensor 481 is changed from ON to OFF (S30: YES), the shaft position obtaining part 564 determines that the screw shaft 46 reaches the non-detection position PD, and shifts the processing to S40. In S40, the shaft position obtaining part 564 starts counting the cumulative number of revolutions of the motor 2.

In S50, the shaft position obtaining part 564 monitors the output of the detection signal from the second sensor 482. If the output of the detection signal from the second sensor 482 is OFF, the shaft position obtaining part 564 determines that the screw shaft 46 does not reach the rear detection position PB (S50: NO), and shifts the processing to S52. In S52, the motor controlling part 562 monitors whether the switch 152 is turned off by releasing operation of the trigger 151. If the switch 152 is turned off (S52: YES), the motor controlling part 562 shifts the processing to S60. If the switch 152 is not turned off within a prescribed time (S52: NO), the motor controlling part 562 returns the processing to S50.

In S50, if the output of the detection signal from the second sensor 482 is changed from OFF to ON (S50: YES), the shaft position obtaining part 564 determines that the screw shaft 46 reaches the rear detection position PB. In S60, the motor controlling part 562 executes control for braking the motor 2. When the rotational speed of the motor 2 becomes zero by braking the motor 2, the screw shaft 46 stops at the stop position PE. In this embodiment, in the rearward movement of the screw shaft 46, the motor controlling part 562 brakes the motor 2 by stopping energization to the motor 2 (by reducing the duty ratio to zero). The motor controlling part 562 may stop the motor 2 by short-circuit braking.

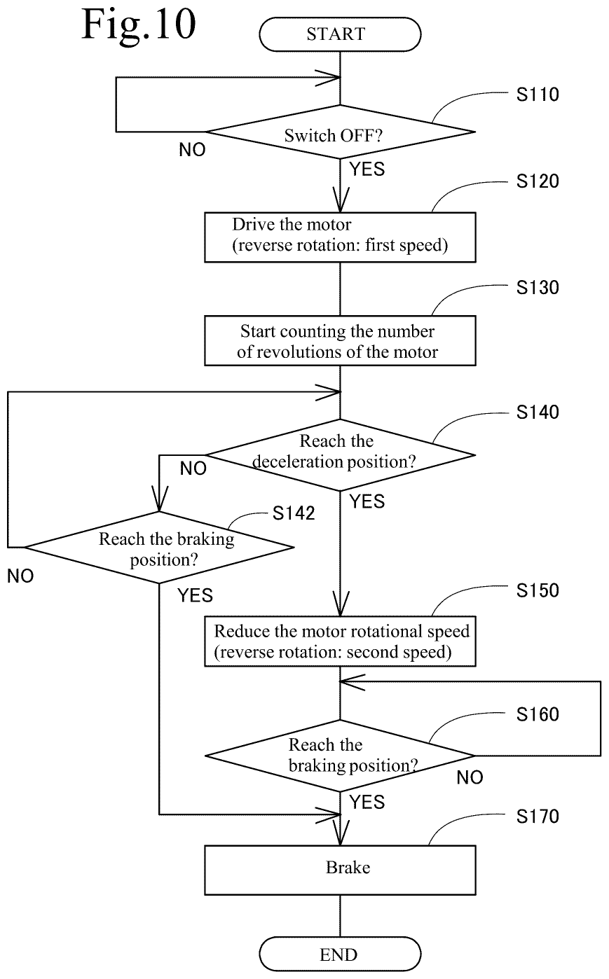

FIG. 10 shows a (second) flow that is started while the screw shaft 46 is moved rearward or stopped at the stop position PE, during depressing operation of the trigger 151.

In S110, the motor controlling part 562 waits for the switch 152 to be turned off by releasing operation of the trigger 151. If the switch 152 is turned off (S110: YES), the motor controlling part 562 shifts the processing to S120, and rotates the motor 2 in the reverse direction and moves the screw shaft 46 forward. The motor controlling part 562 controls the moving speed of the screw shaft 46 to the target speed V1. In S130, the shaft position obtaining part 564 starts counting the cumulative number of revolutions of the motor 2. The processings of S120 and S130 may be executed in any order, or may be executed simultaneously.

In S140, the shaft position obtaining part 564 determines whether the screw shaft 46 reaches the deceleration position P1. Specifically, the shaft position obtaining part 564 monitors the cumulative number of revolutions of the motor 2 and determines whether the result of counting of the cumulative number of revolutions of the motor 2 that is started in S130 reaches the cumulative number of revolutions TH. If the cumulative number of revolutions of the motor 2 does not reach the cumulative number of revolutions TH (S140: NO), the shaft position obtaining part 564 shifts the processing to S142.

In S142, the shaft position obtaining part 564 monitors the output of the detection signal from the first sensor 481, and determines whether the screw shaft 46 reaches the braking position P2. If, for example, the trigger 151 is released before the screw shaft 46 reaches the stop position PE in the rearward movement, the screw shaft 46 may reach the braking position P2 before the cumulative number of revolutions of the motor 2 reaches the cumulative number of revolutions TH.

If the output of the detection signal from the first sensor 481 is OFF (S142: NO), the shaft position obtaining part 564 determines that the screw shaft 46 does not reach the braking position P2, and returns the processing to S140. If the output of the detection signal from the first sensor 481 is changed from OFF to ON (S142: YES), the shaft position obtaining part 564 determines that the screw shaft 46 reaches the braking position P2, and shifts the processing to S170.

In S140, if the cumulative number of revolutions of the motor 2 reaches the cumulative number of revolutions TH (S140: YES), the shaft position obtaining part 564 determines that the screw shaft 46 reaches the deceleration position P1, and shifts the processing to S150. In S150, the motor controlling part 562 starts reducing the rotational speed of the motor 2 so as to reduce the moving speed of the screw shaft 46 from the target speed V1 to the target speed V2.

In S160, the shaft position obtaining part 564 monitors the output of the detection signal from the first sensor 481, and determines whether the screw shaft 46 reaches the braking position P2. If the screw shaft 46 does not reach the braking position P2 (S160: NO), the shaft position obtaining part 564 repeats the processing of S160. If the output of the detection signal from the first sensor 481 is changed from OFF to ON (S160: YES), the shaft position obtaining part 564 determines that the screw shaft 46 reaches the braking position P2, and shifts the processing to S170. In S170, the motor controlling part 562 brakes the motor 2 by short-circuit braking to stop the screw shaft 46, and completes the processing.

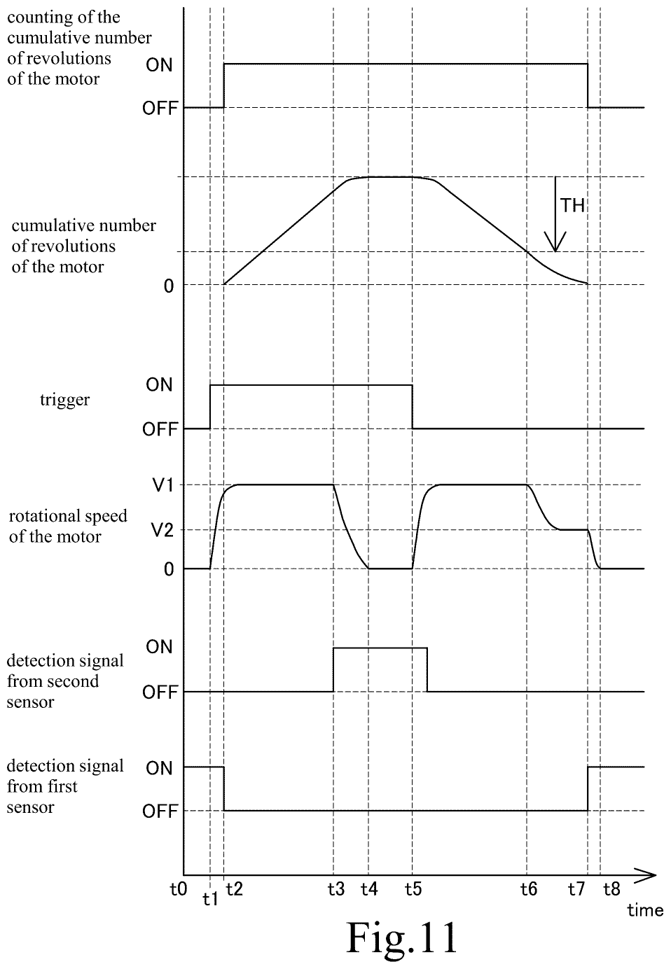

FIG. 11 shows an example of the drive control of the motor 2 when the screw shaft 46 moves rearward to the stop position PE and then moves forward from the stop position PE back to the initial position PS. At time t1, the switch 152 is turned on by depressing operation of the trigger 151. The motor controlling part 562 drives the motor 2 to rotate in the normal direction such that the moving speed of the screw shaft 46 reaches the target speed V1. At time t2, the screw shaft 46 reaches the non-detection position PD, and the detection signal from the first sensor 481 is changed from ON to OFF. The shaft position obtaining part 564 starts counting the cumulative number of revolutions of the motor 2.

At time t3, the screw shaft 46 reaches the rear detection position PB, and the detection signal from the second sensor 482 is changed from OFF to ON. The motor controlling part 562 brakes the motor 2. At time t4, the screw shaft 46 stops at the stop position PE and completes the rearward movement.

At time t5, the switch 152 is turned off by releasing operation of the trigger 151. The motor controlling part 562 drives the motor 2 to rotate in the reverse direction such that the moving speed of the screw shaft 46 reaches the target speed V1. The shaft position obtaining part 564 starts counting the cumulative number of revolutions of the motor 2. At time t6, the cumulative number of revolutions of the motor 2 reaches the cumulative number of revolutions TH, and the motor controlling part 562 drives the motor 2 to reduce the moving speed of the screw shaft 46 to the target speed V2.

At time t7, the screw shaft 46 reaches the braking position P2, and the detection signal from the first sensor 481 is changed from OFF to ON. The motor controlling part 562 brakes the motor 2 by short-circuit braking. At time t8, the screw shaft 46 stops at the initial position PS and completes the forward movement.

As described above, in the fastening tool 1 according to this embodiment, when the screw shaft 46 moves forward and reaches the deceleration position P1, the moving speed of the screw shaft 46 is reduced from the target speed V1 to the target speed V2 by PWM control. The driving of the motor 2 is stopped after the moving speed of the screw shaft 46 is reduced, so that variation in the stop position of the screw shaft 46 is reduced or prevented when the screw shaft 46 stops at the initial position PS in the forward movement. Thus, the occurrence of a problem that the pin gripping part 165 cannot properly grip the pin 91 is avoided or prevented.

In the fastening tool 1 of this embodiment, when the cumulative number of revolutions of the motor 2 that is obtained in the forward movement of the screw shaft 46 reaches the cumulative number of revolutions TH, the shaft position obtaining part 564 determines that the screw shaft 46 reaches the deceleration position P1. Thus, the deceleration position P1 is detected with a small number of parts without the need for providing a member for detecting the deceleration position P1. Further, the deceleration position P1 can be easily set and changed. B. Second Embodiment:

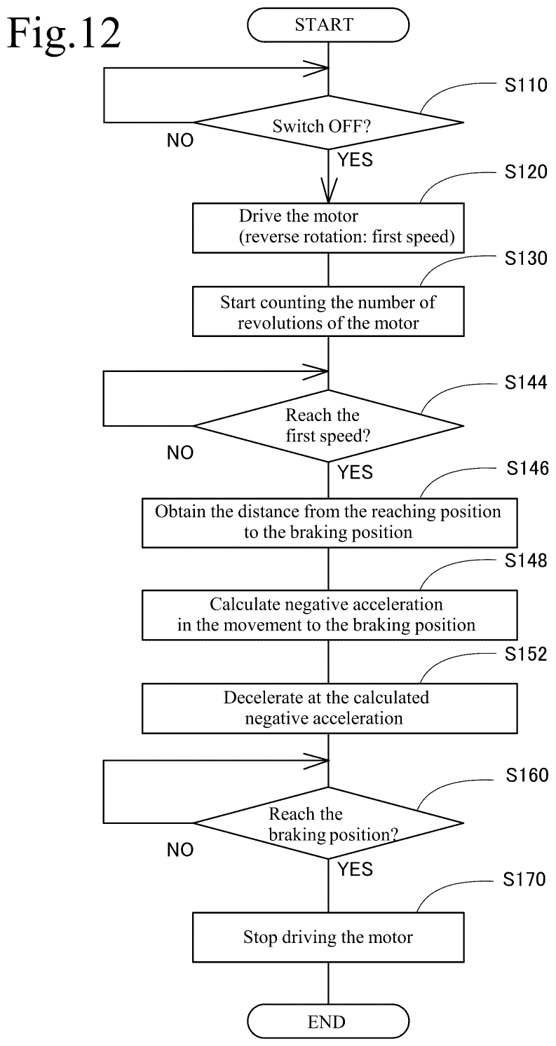

As shown in FIG. 12, the drive control of the motor 2 in the fastening tool 1 according to a second embodiment of the present disclosure is different from that of the first embodiment in that S144, S146, S148 and S152 are provided in place of S140, S142 and S150, and in the other points, the fastening tool 1 of the second embodiment has the same structure as that of the first embodiment. In this embodiment, the moving speed of the screw shaft 46 is reduced at the timing of reaching the target speed V1 in the forward movement.

In S144, the motor controlling part 562 monitors the cumulative number of revolutions of the motor 2 and determines whether the moving speed of the screw shaft 46 reaches the target speed V1. If the cumulative number of revolutions of the motor 2 reaches a prescribed value and the moving speed of the screw shaft 46 reaches the target speed V1 (S144: YES), the shaft position obtaining part 564 shifts the processing to S146.

In S146, the shaft position obtaining part 564 calculates a distance from a position (which is also referred to as a “reaching position”) of the screw shaft 46 at the time of reaching the target speed V1, to the braking position P2. In this embodiment, a distance from the reaching position to the braking position P2 is indicated by the cumulative number of revolutions of the motor 2 in the movement from the reaching position to the braking position P2. In this embodiment, the counting of the cumulative number of revolutions of the motor 2 is started from the non-detection position PD that substantially corresponds to the braking position P2. Thus, the shaft position obtaining part 564 obtains the distance (the cumulative number of revolutions of the motor 2) from the reaching position to the braking position P2 by obtaining the cumulative number of revolutions of the motor 2 in the reaching position.

In S148, the motor controlling part 562 calculates negative acceleration by using the distance (the cumulative number of revolutions of the motor 2) from the reaching position to the braking position P2. The “negative acceleration” means deceleration for decelerating an object. In this embodiment, the motor controlling part 562 calculates the negative acceleration as a fixed value, where the movement of the screw shaft 46 is considered as linear movement at constant negative acceleration, with the moving speed of the screw shaft 46 in the reaching position being set as the target speed V1 and in the braking position P2 as the target speed V2. The cost for calculating the acceleration is reduced by calculating the acceleration as a fixed value. In S152, the motor controlling part 562 drives the motor 2 according to the negative acceleration calculated as a fixed value, and decelerates (reduces the moving speed of) the screw shaft 46 until the screw shaft 46 reaches the braking position P2. The acceleration is not limited to a constant, but it may be a variable.

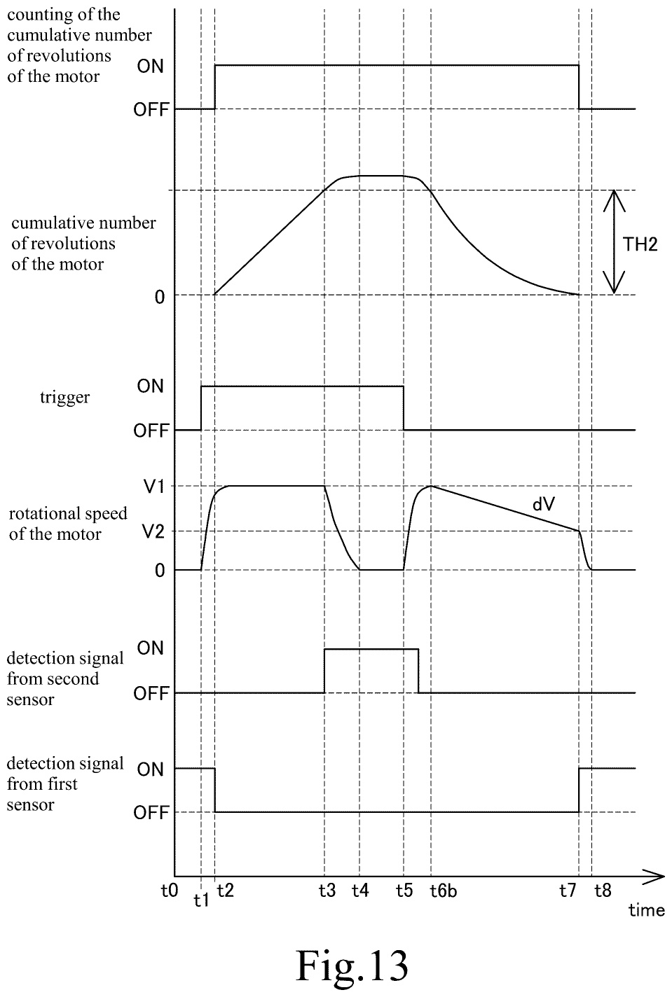

As shown in FIG. 13, at time t5, like in the first embodiment, when the trigger 151 is released, the motor controlling part 562 drives the motor 2 to rotate in the reverse direction such that the moving speed of the screw shaft 46 reaches the target speed V1. When the moving speed of the screw shaft 46 reaches the target speed V2 at time t6b, the shaft position obtaining part 564 obtains the reaching position and calculates a distance (a cumulative number of revolutions TH2 of the motor 2) from the reaching position to the braking position P2. The motor controlling part 562 calculates a negative acceleration dV by using the cumulative number of revolutions TH2 of the motor 2 in the movement from the reaching position to the braking position P2. The motor controlling part 562 drives the motor 2 to reduce the moving speed of the screw shaft 46 at the negative acceleration dV.

In the fastening tool 1 according to this embodiment, the motor controlling part 562 stops driving of the motor 2 after the moving speed of the screw shaft 46 is reduced at the calculated negative acceleration dV. Like in the first embodiment, the driving of the motor 2 is stopped after the moving speed of the screw shaft 46 is reduced, so that variation in the stop position of the screw shaft 46 is reduced or prevented when the screw shaft 46 moves forward and stops at the initial position PS.

In the fastening tool 1 according to this embodiment, the motor controlling part 562 calculates the negative acceleration dV by using the distance from the reaching position to the braking position P2, and drives the motor 2 to reduce the moving speed of the screw shaft 46 at the calculated negative acceleration dV. The negative acceleration is calculated according to the reaching position. Therefore, even if, for example, the reaching position varies due to difference in timing of the releasing operation of the trigger 151, the moving speed in the braking position P2 is changed to the target speed V2. Thus, variation in the stop position of the screw shaft 46 due to variation of the reaching position is reduced or prevented when the screw shaft 46 stops at the initial position PS.

### C: Other Embodiments

(C1) In the above-described first embodiment, the deceleration position P1 is set at a position where the cumulative number of revolutions of the motor 2 reaches the predetermined cumulative number of revolutions TH after start of the forward movement of the screw shaft 46. The deceleration position P1 may however be set rearward of the initial position PS by a predetermined distance (by a distance corresponding to a predetermined cumulative number of revolutions of the motor 2). In this case, the moving speed of the screw shaft 46 can be reduced at a certain position regardless of the position where the screw shaft 46 starts forward movement.

(C2) In the above-described second embodiment, the motor controlling part 562 changes the number of revolutions per unit time of the motor 2 by PWM control for changing the duty ratio outputted to the motor 2. The motor controlling part 562 may however be configured to change the moving speed of the screw shaft 46 by constant-speed rotation control of the motor 2. The “constant-speed rotation control” refers to control for adjusting the driving voltage of the motor 2 such that the number of revolutions per unit time of the motor shaft 25 reaches a predetermined target number of revolutions or less. The moving speed of the screw shaft 46 is accurately changed by constant-speed rotation control. The motor controlling part 562 may execute constant-speed rotation control of the motor 2 to control the target number of revolutions of the motor 2, for example, to 50 to 75 percent of the target number of revolutions of the motor 2 for the forward movement from the stop position PE to the initial position PS.

(C3) The structures of the motor 2, the transmitting mechanism 3 and the driving mechanism 4 can be appropriately changed. For example, the motor 2 may be a motor with a brush, or an AC motor. The number of the planetary gear mechanisms of the planetary reduction gear 31 and the arrangement of the intermediate shaft 33 may be appropriately changed. In the driving mechanism 4, for example, a feed screw mechanism, including a nut having a female thread on its inner periphery and a screw shaft having a male thread on its outer periphery and directly engaged with the nut, may be employed in place of the ball screw mechanism 40 including the nut 41 and the screw shaft 46 engaged with the nut 41 via the balls. The ball screw mechanism 40 may be configured such that the screw shaft 46 is restricted in movement in the front-rear direction and rotatably supported and the nut 41 is moved in the front-rear direction along with rotation of the screw shaft 46. In this case, the pin gripping part 165 is directly or indirectly connected to the nut 41.

(C4) In the above-described embodiments, the first and second sensors 481, 482 are magnetic field detection type sensors, but may be sensors of the other type (e.g., an optical sensor such as a photo interrupter) or mechanical switches.

(C5) In the above-described embodiments, the controller 156 is formed by a computer including a CPU, a ROM and a RAM, but may be formed, for example, by a programmable logic device such as an ASIC (Application Specific Integrated Circuit) and an FPGA (Field Programmable Gate Array). The CPU may execute a program stored in the ROM in order to execute the drive control processing of the above-described embodiments. In this case, the program may be stored in the ROM of the controller 156 beforehand, and if the controller 156 includes a non-volatile memory, the program may be stored in the non-volatile memory. Alternatively, the program may be stored in an external storage medium (such as a USB memory) capable of reading data. The drive control processing of the above-described embodiments and their modifications may be distributed to a plurality of control circuits and executed.

The present disclosure is not limited to any of the above-described embodiments but may be implemented by a diversity of configurations without departing from the scope of the disclosure. For example, the technical features of any of the above embodiments may be replaced or combined appropriately, in order to solve part or all of the problems described above or in order to achieve part or all of the advantageous effects described above. Any of the technical features may be omitted appropriately unless the technical feature is described as essential in the description hereof.

### DESCRIPTION OF THE NUMERALS

1: fastening tool, 2: motor, 3: transmitting mechanism, 4: driving mechanism, 7: collecting container, 9: fastener, 10: housing, 11: outer housing, 13: inner housing, 15: handle, 16: nose, 20: motor body, 21: stator, 23: rotor, 25: motor shaft, 27: fan, 30: reduction gear housing, 31: planetary reduction gear, 33: intermediate shaft, 35: nut driving gear, 40: ball screw mechanism, 41: nut, 46: screw shaft, 47: extension shaft, 48: position detecting mechanism, 49: connecting member, 70: passage, 91: pin, 95: collar, 111: roller guide, 113: container connecting part, 114: opening, 117: guide sleeve, 150: circuit board, 151: trigger, 152: switch, 155: controller housing part, 156: controller, 157: operation part, 158: battery mounting part, 159: battery, 161: anvil, 165: pin gripping part, 201: three-phase inverter, 203: Hall sensor, 205: current detecting amplifier, 311: sun gear, 313: carrier, 411: driven gear, 412: radial bearing, 460: driving shaft, 461: through hole, 463: roller holding part, 464: roller, 481: first sensor, 482: second sensor, 485: magnet holding part, 486: magnet, 560: CPU, 562: motor controlling part, 564: shaft position obtaining part, 565: internal bus, 566: memory, 568: interface circuit, 911: shaft part, 913: small-diameter part, A1: driving axis, A2: rotational axis, OD: external device, W1: workpiece, W2: workpiece

1. A fastening tool that is configured to fasten workpieces via a fastener having a pin and a cylindrical part, comprising:
a motor having a motor shaft;
a housing that houses the motor;
a pin gripping part that is configured to grip the pin;
a driving mechanism that is connected to the pin gripping part, and configured to perform rearward movement of moving rearward from an initial position along a driving axis that defines a front-rear direction of the fastening tool, by normal rotation of the motor shaft, and perform forward movement of moving forward to the initial position along the driving axis by reverse rotation of the motor shaft;
a position obtaining part that is configured to obtain a relative position of the driving mechanism in the front-rear direction relative to the housing; and
a motor controlling part that is configured to execute drive control of the motor to change a moving direction and a moving speed of the driving mechanism;
wherein:
the motor controlling part:
starts the forward movement of the driving mechanism such that the moving speed reaches a first speed;
reduces the moving speed to a second speed lower than the first speed by PWM control for changing a duty ratio outputted to the motor, when the obtained relative position reaches a deceleration position rearward of the initial position in the forward movement; and
stops driving of the motor when the obtained relative position reaches a predetermined braking position forward of the deceleration position and rearward of the initial position.

2. A fastening tool that is configured to fasten workpieces via a fastener having a pin and a cylindrical part, comprising:
a motor having a motor shaft;
a housing that houses the motor;
a pin gripping part that is configured to grip the pin;
a driving mechanism that is connected to the pin gripping part, and configured to perform rearward movement of moving rearward from an initial position along a driving axis that defines a front-rear direction of the fastening tool, by normal rotation of the motor shaft, and perform forward movement of moving forward to the initial position along the driving axis by reverse rotation of the motor shaft;
a position obtaining part that is configured to obtain a relative position of the driving mechanism in the front-rear direction relative to the housing; and
a motor controlling part that is configured to execute drive control of the motor to change a moving direction and a moving speed of the driving mechanism;
wherein:
the motor controlling part:
starts the forward movement of the driving mechanism such that the moving speed reaches a first speed;
reduces the moving speed to a second speed lower than the first speed by constant-speed rotation control for adjusting a driving voltage of the motor such that a number of revolutions per unit time of the motor shaft reaches a predetermined target number of revolutions, when the obtained relative position reaches a deceleration position rearward of the initial position in the forward movement; and
stops driving of the motor when the obtained relative position reaches a predetermined braking position forward of the deceleration position and rearward of the initial position.

3. A fastening tool that is configured to fasten workpieces via a fastener having a pin and a cylindrical part, comprising:
a motor having a motor shaft;
a housing that houses the motor;
a pin gripping part that is configured to grip the pin;
a driving mechanism that is connected to the pin gripping part, and configured to perform rearward movement of moving rearward from an initial position along a driving axis that defines a front-rear direction of the fastening tool, by normal rotation of the motor shaft, and perform forward movement of moving forward to the initial position along the driving axis by reverse rotation of the motor shaft;
a position obtaining part that is configured to obtain a relative position of the driving mechanism in the front-rear direction relative to the housing; and
a motor controlling part that is configured to execute drive control of the motor to change a moving direction and a moving speed of the driving mechanism;
wherein:
the motor controlling part:
starts the forward movement of the driving mechanism such that the moving speed reaches a first speed;
determines a negative acceleration such that the moving speed is reduced to a second speed lower than the first speed in a braking position located at a predetermined distance rearward from the initial position, and reduces the moving speed at the determined (negative) acceleration, when the moving speed reaches the first speed in the forward movement; and
stops driving of the motor when the obtained relative position reaches the braking position.

4. The fastening tool as defined in claim 1, wherein the position obtaining part obtains a cumulative number of revolutions of the motor shaft and obtains the relative position by using the obtained cumulative number of revolutions of the motor shaft.

5. The fastening tool as defined in claim 4, wherein when the cumulative number of revolutions obtained in the forward movement reaches a predetermined cumulative number of revolutions, the position obtaining part determines that the obtained relative position of the driving mechanism reaches the deceleration position.

6. The fastening tool as defined in claim 4, wherein the cumulative number of revolutions of the motor shaft in the forward movement from a position of starting the forward movement to the deceleration position is smaller by a predetermined number of revolutions than the cumulative number of revolutions of the motor shaft in the rearward movement from a position of starting counting the cumulative number of revolutions of the motor shaft in the rearward movement to the position of starting the forward movement.

7. The fastening tool as defined in claim 2, wherein the position obtaining part obtains a cumulative number of revolutions of the motor shaft and obtains the relative position by using the obtained cumulative number of revolutions of the motor shaft.

8. The fastening tool as defined in claim 7, wherein when the cumulative number of revolutions obtained in the forward movement reaches a predetermined cumulative number of revolutions, the position obtaining part determines that the obtained relative position of the driving mechanism reaches the deceleration position.

9. The fastening tool as defined in claim 7, wherein the cumulative number of revolutions of the motor shaft in the forward movement from a position of starting the forward movement to the deceleration position is smaller by a predetermined number of revolutions than the cumulative number of revolutions of the motor shaft in the rearward movement from a position of starting counting the cumulative number of revolutions of the motor shaft in the rearward movement to the position of starting the forward movement.

10. The fastening tool as defined in claim 3, wherein:
the position obtaining part:
obtains a cumulative number of revolutions of the motor shaft, and obtains a reaching position where the moving speed reaches the first speed, by using the obtained cumulative number of revolutions of the motor shaft, and
calculates a distance from the obtained reaching position to the braking position, and
the motor controlling part calculates the negative acceleration by using the calculated distance from the reaching position to the braking position and reduces the moving speed at the calculated negative acceleration.

11. The fastening tool as defined in claim 10, wherein the motor controlling part reduces the moving speed at a constant negative acceleration corresponding to the distance from the obtained reaching position to the braking position.

12. The fastening tool as defined in claim 4, further comprising:
a detected object that is provided in the driving mechanism and moves integrally with the driving mechanism; and
a braking position detecting part that is configured to detect the detected object when the driving mechanism is located in the braking position;
wherein the position obtaining part starts obtaining the cumulative number of revolutions of the motor shaft at a timing when a detection result of the braking position detecting part is changed from a detection state in which the detected object is detected to a non-detection state in which the detected object is not detected, in the rearward movement.

13. The fastening tool as defined in claim 3, wherein the motor controlling part changes the moving speed by PWM control for changing a duty ratio outputted to the motor.

14. The fastening tool as defined in claim 3, wherein the motor controlling part:
executes constant-speed rotation control for adjusting a driving voltage of the motor such that a number of revolutions per unit time of the motor shaft reaches a predetermined target number of revolutions, and
changes the moving speed by changing the target number of revolutions.

15. The fastening tool as defined in claim 1, wherein the motor controlling part stops the motor by short-circuit braking for short-circuiting terminals of the motor.

16. The fastening tool as defined in claim 1, wherein the driving mechanism includes:
a nut that is rotationally driven around the driving axis by power of the motor, and
a shaft that is connected to the pin gripping part, and configured to perform the rearward movement by normal rotation of the motor shaft and perform the forward movement by reverse rotation of the motor shaft.

17. The fastening tool as defined in claim 1, further comprising:
a detected object that is provided in the driving mechanism and moves integrally with the driving mechanism; and
a rear braking position detecting part that is configured to detect the detected object when the driving mechanism is located in a rear braking position rearward of the braking position;
wherein the motor controlling part stops driving of the motor when the detected object is detected by the rear braking position detecting part.

18. The fastening tool as defined in claim 1, further comprising:
a trigger that is configured to be depressed or released by a user,
wherein the motor controlling part drives the motor to rotate the motor shaft in a normal direction when the trigger is depressed, while driving the motor to rotate the motor shaft in a reverse direction when the trigger is released.
